(19) United States
(12) Patent Application Publication
(10) Pub. No.: US 2026/0029801 A1
(43) Pub. Date: Jan. 29, 2026

(54) METHODS AND SYSTEMS FOR ROBOT LEARNING AND CONTROLLING A ROBOT

(71) Applicant: COLLABORATIVE ROBOTICS, Santa Clara, CA (US)

(72) Inventors: Brandon Porter, Santa Clara, CA (US); Michael Vogelsong, Santa Clara, CA (US)

(21) Appl. No.: 19/281,421

(22) Filed: Jul. 25, 2025

Related U.S. Application Data
(60) Provisional application No. 63/676,254, filed on Jul. 26, 2024.

(51) Int. Cl. G05D 1/648; G05D 101/10; G05D 109/10; G05D 111/10

(52) U.S. Cl. CPC G05D 1/648; G05D 2101/10; G05D 2109/10; G05D 2111/10

(57) ABSTRACT

A method may include obtaining input data corresponding to a robot. The method may also include generating, using an artificial intelligence (AI) model, output data based on the input data. The output data may be representative of a state of the robot. In addition, the method may include identifying, using an AI policy model, a set of tasks to be performed by the robot based on the output data. The set of tasks may involve movement of the robot associated with the state of the robot to perform an operation. The method may include causing the robot to autonomously perform the set of tasks to complete the operation.

### CROSS-REFERENCE TO RELATED APPLICATION

This patent application claims the benefit of and priority to U.S. Provisional App. No. 63/676,254 filed Jul. 26, 2024, titled “METHODS FOR ROBOT LEARNING,” which is incorporated in the present disclosure by reference in its entirety.

### FIELD

The embodiments discussed in the present disclosure are related to methods and systems for robot learning and controlling a robot.

### BACKGROUND

Unless otherwise indicated in the present disclosure, the materials described in the present disclosure are not prior art to the claims in the present application and are not admitted to be prior art by inclusion in this section.

Robots have been used in recent years to perform tasks in various facilities including manufacturing, warehouses, logistics, and delivery settings. Robotics has been useful in making tasks more efficient, thereby improving efficiency and lowering costs to operate the facilities.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One or more embodiments of the present disclosure may include a method. The method may include obtaining input data corresponding to a robot. The method may also include generating, using an artificial intelligence (AI) model, output data based on the input data. The output data may be representative of a state of the robot. In addition, the method may include identifying, using an AI policy model, a set of tasks to be performed by the robot based on the output data. The set of tasks may involve movement of the robot associated with the state of the robot to perform an operation. The method may include causing the robot to autonomously perform the set of tasks to complete the operation.

One or more embodiments of the present disclosure may include a system. The system may include one or more computer readable media configured to store instructions. The system may also include a processor coupled to the computer readable media. The processor may be configured to execute the instructions to cause or direct the system to perform operations. The operations may include obtaining input data corresponding to a robot. The operations may also include generating, using an AI model, output data based on the input data. The output data may be representative of a state of the robot. In addition, the operations may include identifying, using an AI policy model, a set of tasks to be performed by the robot based on the output data. The set of tasks may involve movement of the robot associated with the state of the robot to perform an operation. The operations may include causing the robot to autonomously perform the set of tasks to complete the operation.

One or more embodiments of the present disclosure may include a non-transitory computer-readable medium. The non-transitory computer readable medium may include computer-readable instructions stored thereon that are executable by a processor to perform or control performance of operations. The operations may include obtaining input data corresponding to a robot. The operations may also include generating, using an AI model, output data based on the input data. The output data may be representative of a state of the robot. In addition, the operations may include identifying, using an AI policy model, a set of tasks to be performed by the robot based on the output data. The set of tasks may involve movement of the robot associated with the state of the robot to perform an operation. The operations may include causing the robot to autonomously perform the set of tasks to complete the operation.

The object and advantages of the embodiments will be realized and achieved at least by the elements, features, and combinations particularly pointed out in the claims. Both the foregoing general description and the following detailed description are exemplary and explanatory and are not restrictive.

### BRIEF DESCRIPTION OF THE DRAWINGS

Example embodiments will be described and explained with additional specificity and detail through the use of the accompanying drawings in which:

FIG. 1 illustrates a block diagram of an example operational environment in which an autonomous robot may operate;

FIG. 2 illustrates an example image that may be included as a start image in the image data of FIG. 1;

FIGS. 3A-3D illustrates example images that may be generated by the AI model of FIG. 1;

FIG. 4 illustrates a flowchart of an example method to identify a set of tasks to be performed by a robot to complete an operation;

FIG. 5 illustrates an example computing system that may be used for identifying a set of tasks to be performed by a robot to complete an operation, all according to at least one embodiment described in the present disclosure.

### DETAILED DESCRIPTION

A robot may receive data that includes instructions to perform operations. The instructions may identify one or more tasks that are to be performed by the robot to complete the operations. The robot may be configured to move (e.g., joints, limbs, or any appropriate part) based on the instructions to complete the operations.

The instructions may be generated for each specific operation, task, or both and may take a significant amount of time to develop (e.g., hours, a day, days, a week, or longer). For example, the instructions may be developed by a programmer using repetitive trial and error testing in a controlled environment. Additionally or alternatively, the instructions may be generated for specific environments or static environments (e.g., environments that do not include mobile or dynamic objects) of the robot. Further, generating and managing the instructions for complex operations that include multiple tasks or sub-tasks for the robot can quickly become cumbersome for the developer.

Some robots may be configured to operate based only on the instructions that are generated for a specific environment. Accordingly, these robots may not be able to operate in new or different environments. Additionally or alternatively, these robots may not be able to operate in the new or different environments without new instructions being developed by the programmer (e.g., without using a lot of time for programmers to develop the instructions). Additionally, these robots may not be able to quickly adapt to changes in the environment and may stop performing the tasks to request further instructions in response to the changes. These robots may cause delays, which can impact operational efficiency of the robots and may prevent the robots from maintaining continuous autonomous operation.

Thus, there is a need for a robot that can identify the tasks without the significant amount of time it takes a programmer to develop the instructions to allow the robot to operate in dynamic, new, or different environments.

A robot in accordance with embodiments described in the present disclosure may include an AI policy model that is initially configured to identify tasks of the robot based on initial parameters. Additionally, the robot may execute an AI model to generate output data that includes images, videos, descriptions, latent representations or mathematical representations of parts or of the entire robot, or some combination thereof that is representative of parameters of tasks. Further, the robot may train an AI policy model to identify tasks to be performed by the robot to complete the operation using the output data. Additionally or alternatively, the robot may execute the AI policy model to identify a set of tasks to be performed by the robot to complete the operation based on the output data and the initial parameters.

According to at least one embodiment described in the present disclosure, a computing device of the robot may obtain input data corresponding to the robot. The computing device may also generate, using the AI model, output data based on the input data. The output data may be representative of a state of the robot. For example, the output data may be representative of a position or a sequence of positions of a part or the whole robot or an environment of the robot. In addition, the computing device may identify, using the AI policy model, a set of tasks to be performed by the robot based on the output data. The set of tasks may involve movement of the robot associated with the state of the robot to perform an operation. Further, the computing device may cause the robot to autonomously perform the set of tasks to complete the operation.

As described briefly above and in more detail below, the robot may execute the AI policy model to identify the set of tasks based on the output data, which may enhance functionality and adaptability of the robot. Additionally or alternatively, the robot may execute the AI policy model to identify the set of tasks based on the output data to permit the robot to operate in dynamic, new, or different environments. Further, the robot may execute the AI policy to identify tasks that relate to operations that are not well defined. Accordingly, the robot described in the present disclosure provides improvements to the technical field of robotics, autonomous operation of robots, or both.

These and other embodiments of the present disclosure will be explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

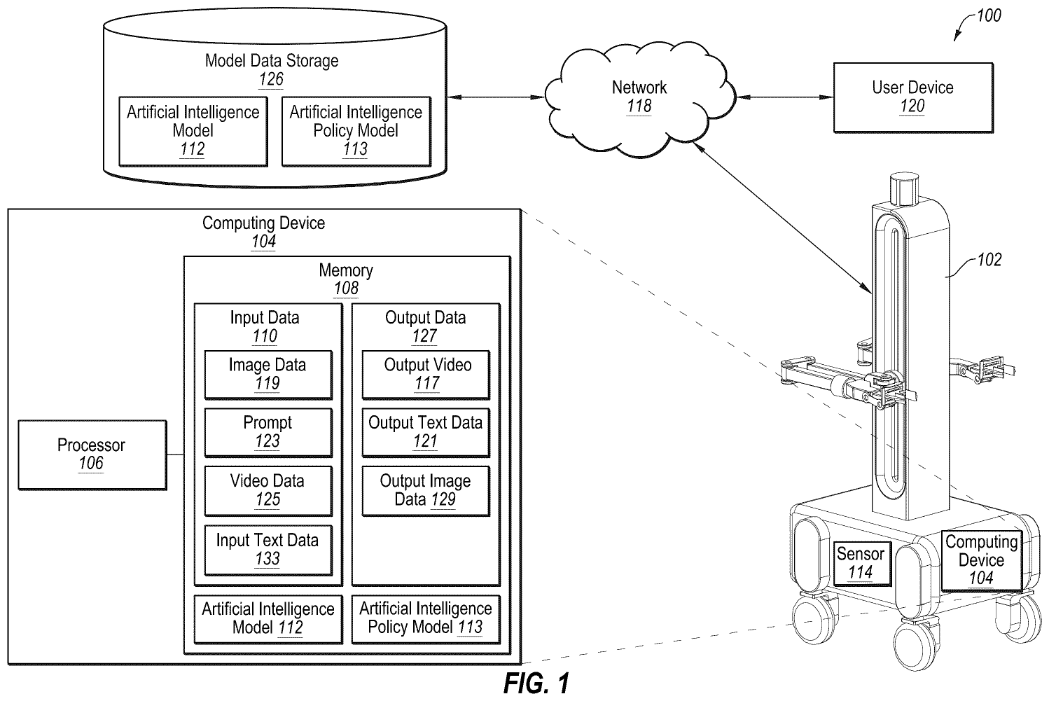

FIG. 1 illustrates a block diagram of an example operational environment 100 in which an autonomous robot 102 (generally referred to in the present disclosure as robot 102) may operate, in accordance with at least one embodiment described in the present disclosure. The environment 100 may include any location in which the robot 102 may operate. For example, the environment 100 may include a warehouse, a hospital, a campus, a building, a field, a construction site, and the like.

The environment 100 may include the robot 102, a network 118, a model data storage 126, or a user device 120. The robot 102 may include a computing device 104 or a sensor 114. The sensor 114 may include a camera, a video camera, a lidar sensor, an infrared sensor, a proximity sensor, a gyroscope, an accelerometer, a magnetometer, a temperature sensor, a pressure sensor, a microphone, a touch sensor, a force sensor, a torque sensor, an ultrasonic sensor, a radar sensor, a GPS sensor, an inertial measurement unit, a depth sensor, a thermal sensor, a light sensor, a motion sensor, a vibration sensor, a current sensor, a voltage sensor, or any other appropriate sensor.

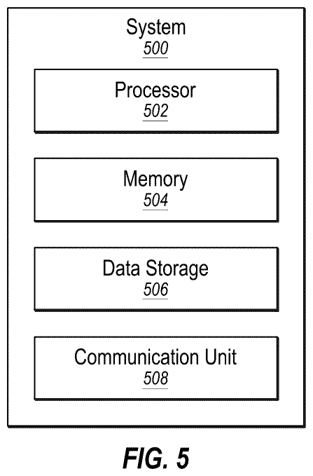

The computing device 104 or the user device 120 may include a desktop computer, a laptop computer, a smartphone, a mobile phone, a tablet computer, a server, a processing system, or any other computing system or set of computing systems that may be used for performing the operations described in this disclosure. An example of such a computing system is described below with reference to FIG. 5. The computing device 104 may include a processor 106 or a memory 108.

The processor 106 may include a central processing unit (CPU), a microprocessor (μP), a microcontroller (μC), a digital signal processor (DSP), a field-programmable gate array (FPGA), an application-specific integrated circuit (ASIC), or any combination thereof. The processor 106 may be configured to execute computer instructions that, when executed, cause the processor 106 or the computing device 104, to perform or control performance of one or more of the operations described herein with respect to operation of the robot 102. The processor 106 may be implemented using a combination of hardware and software. In the present disclosure, operations described as being performed by the processor 106 or the computing device 104 may include operations that the processor 106 or the computing device 104 directs a corresponding system to perform.

The memory 108 may include a storage medium such as a RAM, persistent or non-volatile storage such as ROM, EEPROM, CD-ROM, or other optical disk storage, magnetic disk storage or other magnetic storage device, NAND flash memory or other solid state storage device, or other persistent or non-volatile computer storage medium. The memory 108 may store computer instructions that may be executed by the processor 106 or the computing device 104 to perform or control performance of one or more of the operations described herein with respect to operation of the robot 102. In addition, the memory 108 may store the AI model 112, the AI policy model 113, or both persistently and/or at least temporarily. Further, the memory 108 may store input data 110, output data 127, or any other appropriate data persistently and/or at least temporarily.

The network 118 may include any communication network configured for communication of signals between any of the components (e.g., 102, 120, or 126) of the environment 100. The network 118 may be wired or wireless. The network 118 may have numerous configurations including a star configuration, a token ring configuration, or another suitable configuration. Furthermore, the network 118 may include a local area network (LAN), a wide area network (WAN) (e.g., the Internet), and/or other interconnected data paths across which multiple devices may communicate. In some embodiments, the network 118 may include a peer-to-peer network. The network 118 may also be coupled to or include portions of a telecommunications network that may enable communication of data in a variety of different communication protocols.

In some embodiments, the network 118 includes or is configured to include a BLUETOOTH® communication network, a Z-Wave® communication network, an Insteon® communication network, an EnOcean® communication network, a wireless fidelity (Wi-Fi) communication network, a ZigBee communication network, a HomePlug communication network, a Power-line Communication (PLC) communication network, a message queue telemetry transport (MQTT) communication network, a MQTT-sensor (MQTT-S) communication network, a constrained application protocol (CoAP) communication network, a representative state transfer application protocol interface (REST API) communication network, an extensible messaging and presence protocol (XMPP) communication network, a cellular communications network, any similar communication networks, or any combination thereof for sending and receiving data. The data communicated in the network 118 may include data communicated via short messaging service (SMS), multimedia messaging service (MMS), hypertext transfer protocol (HTTP), direct data connection, wireless application protocol (WAP), e-mail, smart energy profile (SEP), ECHONET Lite, OpenADR, or any other protocol that may be implemented with the components (e.g., 102, 120, or 126) of the environment 100.

The model data storage 126 may include any memory or data storage. The model data storage 126 may include network communication capabilities such that other components (e.g., 102 or 120) in the environment 100 may communicate with the model data storage 126. For example, the computing device 104 may obtain the AI model 112, the AI policy model 113, or any other appropriate data from the model data storage 126. In some embodiments, the model data storage 126 may include computer-readable storage media for carrying or having computer-executable instructions or data structures stored thereon. The computer-readable storage media may include any available media that may be accessed by a general-purpose or special-purpose computer, such as a processor. For example, the model data storage 126 may include computer-readable storage media that may be tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and that may be accessed by a general-purpose or special-purpose computer. Combinations of the above may be included in the model data storage 126.

The computing device 104 may obtain the AI policy model 113, the AI model 112, or both. In some embodiments, the computing device 104 may obtain the AI policy model 113, the AI model 112, or both from the model data storage 126 via the network 118. In other embodiments, the computing device 104 may generate the AI policy model 113, the AI model 112, or both. Examples of the AI model 112 or the AI policy model 113 include, but are not limited to, a large language model, a logic model, a rule-based model (e.g., if-then rules), a decision tree model, a convolutional neural network model, a linear regression model, a logistic regression model, a supervised learning model, an unsupervised learning model, a deep learning model, a machine learning model, any other appropriate AI model, or some combination thereof.

The AI policy model 113 may include a primary model for controlling the robot 102. The AI policy model 113 may be configured to identify or determine tasks (e.g., movements of joints, limbs, or other parts) of the robot 102. For example, the AI policy model 113 may identify or determine tasks of the robot 102 to interface with an object (not shown) in the environment 100. The AI model 112 may include a secondary model for controlling the robot 102. The AI model 112, as described in more detail below, may generate the output data 127 for the AI policy model 113 to identify a set of tasks to be performed by the robot 102 based on the output data 127 and parameters of the AI policy model 113.

The AI policy model 113 may initially be configured to identify the tasks of the robot 102 to complete operations in accordance with initial parameters. The initial parameters may include information describing details of various tasks to be performed or the operation to be completed by the robot 102. In some embodiments, the initial parameters may be based on instructions that are developed by a programmer. In these and other embodiments, the initial parameters may correspond to a particular environment, different operations in different environments, different areas of the environment 100, or any other factor that may be different than in the environment 100.

As described in more detail below, the AI policy model 113 may be trained to identify the set of tasks of the robot 102 to complete the operation based on the output data 127 and the initial parameters. The output data 127 may include parameters describing additional or updated details of the tasks to be performed by the robot 102 to complete the operation. For example, the parameters of the output data 127 may include information describing details of various tasks to be performed specific to the environment 100. As another example, the parameters of the output data 127 may include latent representations or mathematical representations of parts or of the entire robot 102.

The computing device 104 may receive or otherwise obtain the input data 110. In some embodiments, the computing device 104 may receive the input data 110 from at least one of an operator (not shown) of the robot 102, the operator via the user device 120, the sensor 114, or some combination thereof. For example, the computing device 104 may receive the input data 110 as operator input from the user device 120 via the network 118. As another example, the computing device 104 may receive image data 119 of the input data 110 from the sensor 114 (e.g., a camera).

The input data 110 may correspond to a task being performed or to be performed by the robot 102. The input data 110 may indicate or highlight information that the robot 102 is to consider when performing the tasks in the environment 100. In addition, the input data 110 may highlight, identify, or select features in the environment 100 that the robot 102 is to perform the tasks in consideration of. For example, the input data 110 may identify an object that the robot 102 is to perform tasks on, or an object the robot 102 is to avoid, or an area of the environment 100 that the robot 102 is not to enter. As described in more detail below, the input data 110 may include a language type input, an image type input, a video type input, or any other appropriate type of input.

The input data 110 may include a prompt 123 provided by the operator. The computing device 104 may receive the prompt 123 from the user device 120. Additionally or alternatively, the computing device 104 may generate the prompt 123 based on a verbal statement by the operator that is recorded by the sensor 114. In other words, the sensor 114 may record the verbal statement and the computing device 104 may convert the verbal statement to text.

The prompt 123 may identify details related to the tasks of the robot 102. For example, the prompt 123 may relate to objects that the robot 102 is to interact with, movements of parts of the robot 102, or any other appropriate detail. As another example, the prompt 123 may describe a range of motion for a part of the robot 102 or identify a sequence of planned actions such as joint positions or effector poses, a current position of a joint, a history of joint positions, a current effector pose, or a history of effector poses. The prompt 123 may describe details related to the tasks of the robot 102 or the operation to be completed by the robot 102. For example, the prompt 123 may state, “secure the object using the arm of the robot.”

In some embodiments, the prompt 123 may identify details related to corresponding tasks. The corresponding tasks may include tasks that share similar operational characteristics to the tasks of the robot 102 but differ in execution parameters or environmental contexts. Additionally, the corresponding tasks may include tasks performed in relation to different objects, tasks performed in different sequences in different environments, or manipulations tasks performed on different objects. For example, the corresponding tasks may include pick and place tasks involving a box and the tasks of the robot 102 may include pick and place tasks involving a cup.

The image data 119 may show (e.g., visually represent) a part of the robot 102, the entire robot 102, a part of the environment 100, or the entire environment 100. For example, the image data 119 may show a limb, an effector, a hand, an arm, a foot, a leg, a head, a joint, or any other appropriate part of the robot 102. As another example, the image data 119 may show the robot 102 and an object (not shown in FIG. 1) in the environment 100.

In some embodiments, the image data 119 may be associated with the corresponding tasks. The image data 119 may include one or more images showing performance of tasks that share similar operational characteristics, that are being performed by a related device, or both. For example, the image data 119 may include one or more images showing the robot 102 performing pick and place tasks involving a box and the tasks of the robot 102 may include pick and place tasks involving a cup. As another example, the image data 119 may include one or more images showing a related device (e.g., a human hand or another robot) performing the corresponding tasks (e.g., a related task).

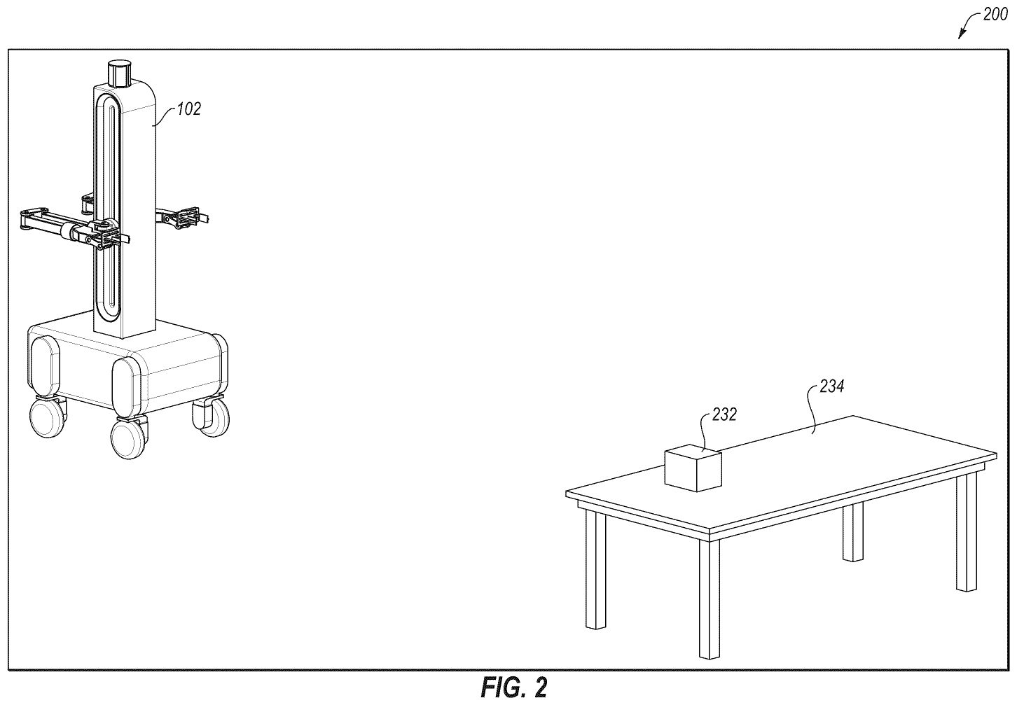

The image data 119 may include a single image or multiple images. The image data 119 may include a start image showing a current position of a part of the robot 102. FIG. 2 illustrates an example image 200 that may be included as a start image in the image data 119 of FIG. 1, in accordance with at least one embodiment described in the present disclosure.

As shown in FIG. 2, the image 200 shows the entire robot 102, an object 232, and a table 234. The object 232 and the table 234 may form part of the environment 100 of FIG. 1. In addition, the image 200 shows a state of the robot 102 (e.g., a position of the robot 102). Further, the image 200 shows a state of the object 232 and the table 234 (e.g., that the object 232 is on the table 234). Additionally, as shown in FIG. 2, the robot 102 is shown relative to the object 232 and the table 234. The image 200 may be generated by the user device 120, the sensor 114, or both.

Referring back to FIG. 1, the image data 119 may include the start image and a final image (e.g., a goal image). The final image may show a final position of the part of the robot 102 to perform a task. For example, the final image may show the robot 102 interfacing with an object or the robot 102 being positioned proximate to an object. The image data 119 may include a sequence of images that show intermediate states of the robot 102. For example, the image data 119 may include a sequence of images showing different positions of a part of the robot 102 along the range of motion of the part.

Video data 125 of the input data 110 may show a part of the robot 102, the entire robot 102, a part of the environment 100, the entire environment 100, or some combination thereof. For example, the video data 125 may represent a temporal sequence of the robot 102 transitioning through multiple states (e.g., multiple positions or poses). As another example, the video data 125 may show a part of the robot 102 and an object (not shown in FIG. 1) in the environment 100.

In some embodiments, the video data 125 may be associated with the corresponding tasks. The video data 125 may show performance of tasks that share similar operational characteristics, that are being performed by a related device, or both. For example, the video data 125 may show the robot performing pick and place tasks involving a box and the tasks of the robot 102 may include pick and place tasks involving a cup. As another example, the video data 125 may show a related device (e.g., a human hand or another robot) performing the corresponding tasks (e.g., a related task).

In some embodiments, the computing device 104 may process the image data 119, the video data 125, or both to generate input text data 133. The input text data 133 may include textual descriptions that characterize the image data 119, the video data 125, or both. For example, the computing device 104 may analyze visual features shown in the image data 119, the video data 125, or both and convert these features into structured textual representations in the input text data 133 that describe objects, poses, and spatial relationships shown in the image data 119, the video data 125, or both. The computing device 104 may utilize natural language processing capabilities to generate the input text data 133 based on the image data 119, the video data 125, or both.

The computing device 104 may execute the AI model 112 using the input data 110 to generate the output data 127. The output data 127 may represent or identify one or more states (e.g., positions) of the robot 102. In other words, the output data 127 may represent tasks of the robot 102. For example, the output data 127 may represent or identify a target position of the robot 102, a target orientation of the robot 102, a target configuration of joints of the robot 102, a target manipulation of an object by the robot 102, or any other appropriate state of the robot 102. Additionally or alternatively, the output data 127 may represent or identity one or more states of the environment 100. Additionally or alternatively, the output data 127 may represent simulated movement of the robot 102 based on the input data 110.

The output data 127 may include an output video 117, output image data 129, output text data 121, or some combination thereof that are generated by the AI model 112. The output data 127 may identify states of the robot 102 or the environment 100 (e.g., parameters) related to the task to be performed by the robot 102 in at least one of a language format (e.g., text format) (e.g., the output text data 121), an image format (e.g., the output image data 129), or a video format (e.g., the output video 117).

The output image data 129 may include one or more images that show tasks or other states of the robot 102, the environment 100, or both to complete the operation. For example, the output image data 129 may include one or more images showing different positions of the robot 102 or the part of the robot 102 to perform the tasks and complete the operation. As another example, the output image data 129 may include the start image, the final image, or the sequence of images that are generated by the AI model 112 based on the input data 110. The output image data 129 may show states of the robot 102 to interface with a simulated object.

The output video 117 may show the tasks or other states of the robot 102 or the environment 100 to complete the operation. The output video 117 may show a temporal sequence of tasks (e.g., states or movements) by the robot 102 to perform the tasks and complete the operation. In addition, the output video 117 may show a temporal sequence of simulated movements of the robot 102. The output video 117 may show a temporal sequence of states of the robot 102 to interface with a simulated object to perform pick and place tasks to complete the operation. For example, the image data 119 may show an arm of the robot 102 and the prompt 123 may state, “generate a video of the arm grabbing an apple and moving the apple to a shelf” and the computing device 104 may execute the AI model 112 to generate the output video 117 to represent a temporal sequence of states of the arm of the robot 102 moving to grab the simulated apple off the table and placing the apple on the shelf.

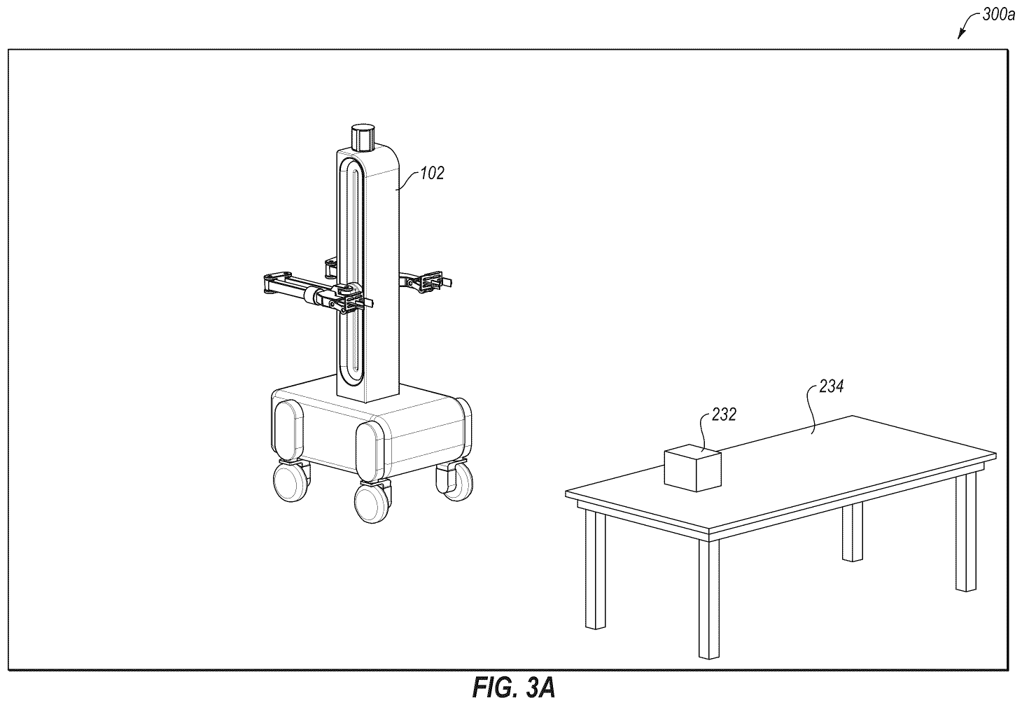

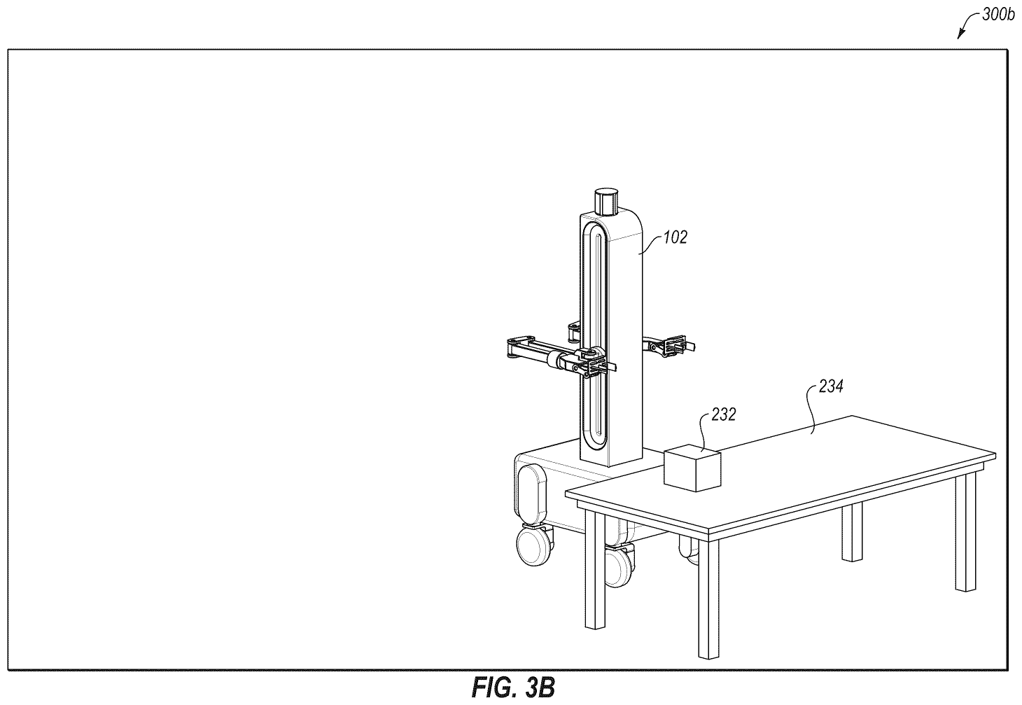

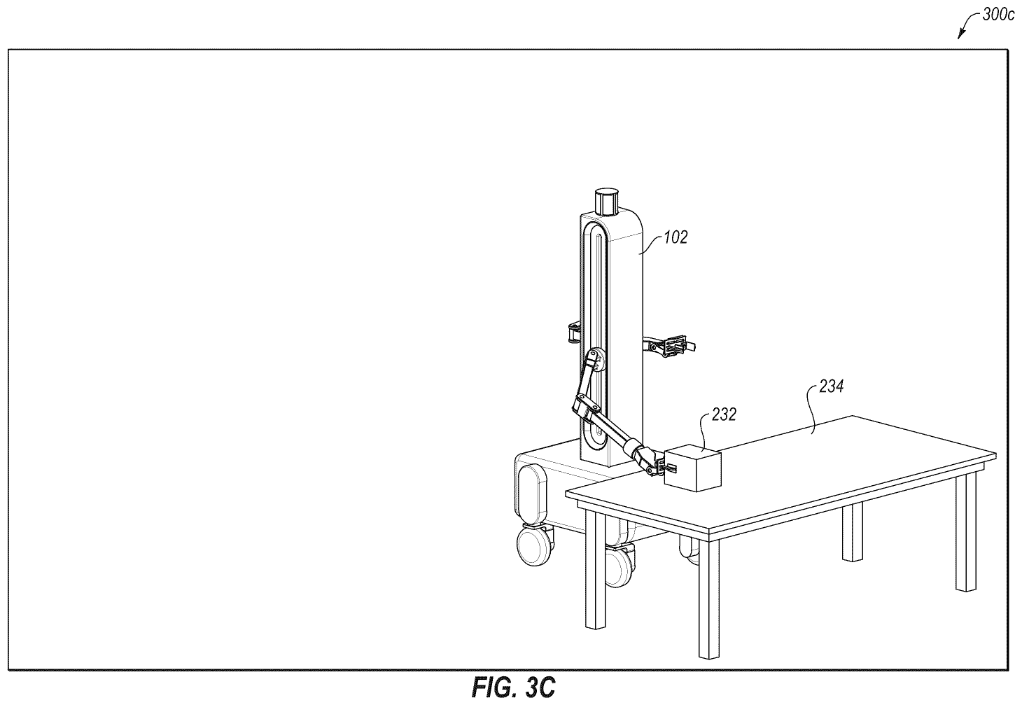

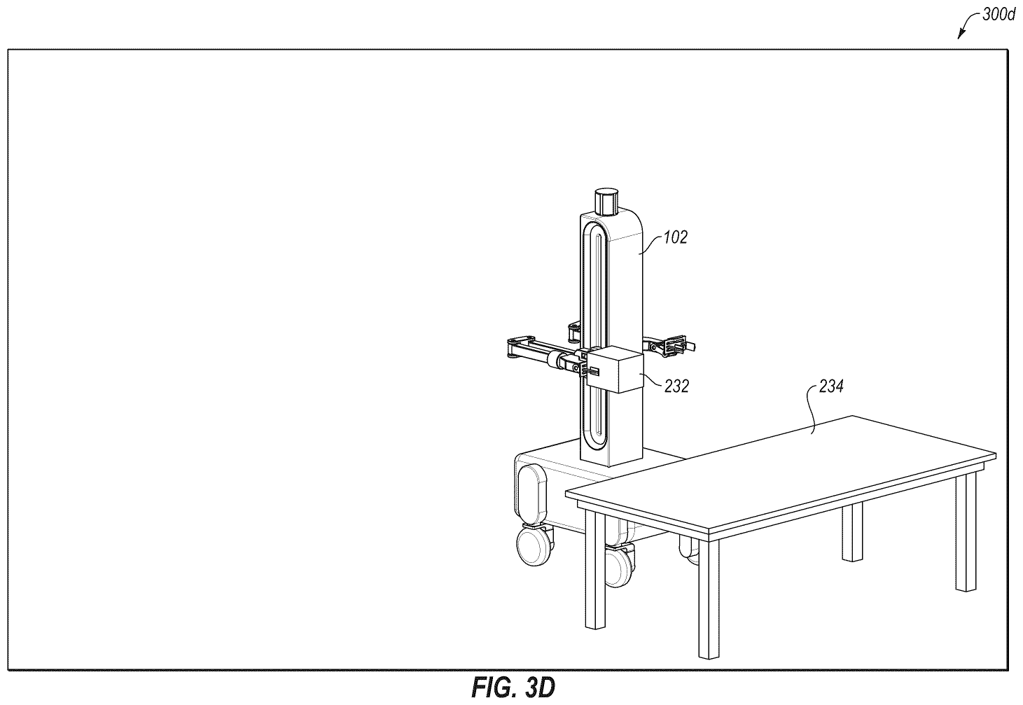

FIGS. 3A-3D illustrates example images 300a-d that may be generated by the AI model 112 of FIG. 1, in accordance with at least one embodiment of the present disclosure. As shown in FIGS. 3A-3D, the images 300a-d show the entire robot 102, the object 232, and the table 234. In addition, the images 300a-d show different tasks or states of the robot 102, the object 232, or both to complete an operation. Additionally, as shown in FIGS. 3A-3D, the robot 102 is shown relative to the object 232 and the table 234.

With reference to FIGS. 1-3D, the images 300a-d may form separate images in the output image data 129. Alternatively, the images 300a-d may be included in the output video 117. The computing device 104 may execute the AI model 112 using the image 200 of FIG. 2 and the prompt 123 stating “generate multiple images of the robot picking up the object on the table” or stating, “generate a video of the robot picking up the object on the table.” Accordingly, the computing device 104 may execute the AI model 112 using the image 200 to generate the images 300a-d corresponding to the task of picking up the object 232 on the table 234.

The AI model 112 may generate the images 300a-d to show or identify multiple states (e.g., positions) of the robot 102 to perform the tasks and complete the operation. In other words, the images 300a-d may show simulated movement of the robot 102 that is based on the input data 110. Additionally or alternatively, the images 300a-d may show different states of the robot 102, the object 232, or both.

As shown in FIGS. 3A and 3B, the AI model 112 may generate the images 300a-b to show states or tasks of the robot 102 that include approaching the table 234 and being positioned proximate to the table 234, respectively. In addition, as shown in FIG. 3C, the AI model 112 may generate the image 300c to show a state or task of the robot 102 that includes grabbing the object 232. Further, as shown in FIG. 3D, the AI model 112 may generate the image 300d to show a state or task of the robot 102 lifting the object 232 from a surface of the table 234. In other words, the image 300d may correspond or include the final image for the operation and may identify the target position of the robot 102 relative to the object 232 and the table 234.

Referring back to FIG. 1, in some embodiments, the simulated object in the output video 117, the output image data 129, or both may correspond to a particular type of object (e.g., a can, a piece of fruit, or a utensil) and the object for which the robot 102 is to perform the tasks may correspond to the same type of object. In other embodiments, the simulated object in the output video 117, the output image data 129, or both may correspond to a particular type of object (e.g., a can, a piece of fruit, or a utensil) and the object for which the robot 102 is to perform the tasks may correspond to a related but different type of object (e.g., a bottle rather than a can).

The output text data 121 may include a textual description of the tasks or the environment 100 shown in the output video 117, the output image data 129, or both. The textual description within the output text data 121 may characterize the output image data 129, the output video 117, or both. For example, the computing device 104 may analyze visual features shown in the output video 117, the output image data 129, or both and convert these features into structured textual representations in the output text data 121 that describe objects, poses, and spatial relationships shown in the output video 117, the output image data 129, or both. The computing device 104 may utilize natural language processing capabilities to generate the output text data 121 based on the output video 117, the output image data 129, or both.

Additionally or alternatively, the output text data 121 may include text describing latent states of the robot 102 to perform the tasks and complete the operation. The output text data 121 may describe the latent states of the robot 102 in machine readable code, natural language (e.g., human readable text), or both. The latent states may represent compressed versions of various states of the robot 102 to perform the tasks. The latent states may include lower-dimensional or compressed information that may allow for more efficient processing and storage compared to higher-dimensional or uncompressed information.

In some embodiments, the output data 127 may include a score indicating how well the output data 127 relates to tasks (e.g., a feedback score). For example, the computing device 104 may receive the prompt 123 stating “On a scale of 1 to 10, how well did the trajectory match the task of moving a load to a storage room” and the computing device 104 may execute the AI model 112 to generate a score of one when the trajectory did not match and a score of ten when the trajectory matched completely. The higher score may reinforce movement of the robot 102 within the environment 100.

The computing device 104 may execute the AI policy model 113 to identify a set of tasks to be performed by the robot 102 based on the output data 127, the initial parameters, or both. The set of tasks may include a high-level motion plan for the robot 102. For example, the set of tasks may include a high-level motion plan for the robot 102 to approach an object and interface with the object. The set of tasks may involve movement of the robot 102 in accordance with the simulated movements shown in the output video 117, the output image data 129, or both.

The set of tasks may involve movements between states by the robot 102, updated parameters of the tasks, or any other appropriate aspect to complete the operation. For example, the computing device 104 may execute the AI policy model 113 to identify the set of tasks that involve movements by the robot 102 to interface with an object in the environment 100. Additionally, the set of tasks may involve movements of the robot 102 associated with the state of the robot 102 to perform the operation. For example, the set of tasks may include movements of the robot 102 between the states of the robot 102 identified in the output data 127.

The computing device 104 may execute the AI policy model 113 to extract estimated joint positions of parts or the entire robot 102 from the output video 117, the output image data 129, or both. Additionally or alternatively, the computing device may execute the AI policy model 113 to identify the estimated joint positions of the parts or the entire robot 102 based on the latent states identified in the output text data 121. The AI policy model 113 may utilize the latent states to identify the set of tasks without requiring complete state information of the parts or the entire robot 102. The different states of the robot 102 may include or be identified as multiple mapped points based on the extracted estimated joint positions. For example, the AI policy model 113 may be configured to extract and determine that “robotic joint A is in position X, Y, Z” and “robotic joint B is in position T, U, V”, over a series of video frames in the output video 117. In addition, the computing device 104, the AI policy model 113, or both may be configured to map the extracted points to the robot 102 to permit the set of tasks to be performed by the robot 102.

The computing device 104 may cause the robot 102 to autonomously perform the set of tasks to complete the operation. For example, the computing device 104 may cause various signals to be generated to actuate actuators (not shown) of the robot 102 to move the robot 102 in accordance with the set of tasks. As another example, the computing device 104 may cause the robot 102 to move to interface with an object in accordance with the set of tasks. Accordingly, the robot 102 may autonomously perform the set of tasks to complete the operation.

In some embodiments, to cause the robot 102 to autonomously perform the set of tasks, the computing device 104 may cause a current operation being performed by the robot 102 to be updated in accordance with the set of tasks. Accordingly, the computing device 104 may cause the current operation to be updated in accordance with a current state of the environment 100 (e.g., another object moving) or a current state of the robot 102 (e.g., from a current position of the robot 102 rather than a previous position of the robot 102).

In some embodiments, to cause the robot 102 to autonomously perform the set of tasks, the computing device 104 may create updated parameters of the current operation in accordance with the set of tasks. The updated parameters may replace corresponding parameters of the tasks being performed by the robot 102. The computing device 104 may create the updated parameters to adjust positions, poses, or any other appropriate aspect of the robot 102. The updated parameters may cause the tasks being performed by the robot 102 to align with the set of tasks identified by the AI policy model 113. For example, the set of tasks may identify updated joint angle parameters, velocity parameters, acceleration parameters, or trajectory parameters to align the tasks being performed by the robot 102 with the set of tasks.

In some embodiments, to cause the robot 102 to autonomously perform the set of tasks, the computing device 104 may adjust the parameters of the current operation in accordance with the set of tasks. The computing device 104 may adjust the parameters to fine tune the parameters of the tasks being performed by the robot 102.

Various examples of input data 110 and output data 127 will now be discussed. In a first example, the image data 119 includes the start image representative of a starting state or a current state of the robot 102. For example, the image data 119 may be captured by the sensor 114, which may show a position of various parts of the robot 102. The computing device 104 may execute the AI model 112 using the image data 119 including the start image to generate the output image data 129 including the final image of the robot 102. Accordingly, the output image data 129 shows a final state of the robot 102 to perform the tasks.

In a second example, the image data 119 includes the start image representative of the starting state or a current state of the robot 102. For example, the image data 119 may be received from the user device 120 that captured an image showing positions of various parts of the robot 102. The computing device 104 may execute the AI model 112 using the image data 119 including the start image to generate the output image data 129 including the final image of the robot 102. Additionally, the computing device 104 may execute the AI model 112 to generate the output video 117 showing multiple intermediate states of the robot 102 based on the image data 119 and the output image data 129. The intermediate states of the robot 102 may include states between the starting state and the final state. In other words, the output video 117 connects the starting state and the final state of the robot 102 by movements of the robot 102.

In a third example, the image data 119 includes the start image representative of the starting state or a current state of the robot 102. In addition, the prompt 123 may describe a task to be performed by the robot 102 (e.g., “grab the object on the desk”). In some embodiments, the computing device 104 may execute the AI model 112 using the image data 119 including the start image and the prompt 123 to generate the output image data 129 including the final image of the robot 102. In these and other embodiments, the computing device 104 may execute the AI model 112 to generate the output video 117 based on the image data 119 and the prompt 123.

In a fourth example, the image data 119 may include a sequence of images showing different states of the robot 102 and the environment 100 in relation to a task. In addition, the prompt 123 may describe a series of tasks to be performed by the robot 102. For example, the prompt 123 may describe a first task as “pick up object with right arm,” a second task as “switch object from right arm to the left arm,” and a third task as “place object onto square on table.” The computing device 104 may execute the AI model 112 using the prompt 123 and the image data 119 to generate the output video 117 showing the robot 102 picking up the object with its right arm, switching the object from the right arm to the left arm, and then placing the object onto a square on the table.

In some embodiments, the AI policy model 113 may not be initially configured to identify or control movements of the parts of the robot 102. In these and other embodiments, the computing device 104 may train the AI policy model 113 to identify or control the movements based on the output data 127.

The computing device 104 may be configured to train the AI policy model 113 using the input data 110 and the AI model 112 to identify the set of tasks based on the output data 127, the initial parameters, or both. The AI model 112 may provide feedback, input, or both to the AI policy model 113 via the output data 127 to permit the computing device 104 to continuously train and update the AI policy model 113.

In some embodiments, the computing device 104 may train the AI policy model 113 using the prompt 123, the output video 117, the output image data 129, or some combination thereof (e.g., training output data). The AI policy model 113 may process the prompt 123, the output video 117, or the output image data 129 to identify movements of the robot 102. The AI policy model 113 may learn to map visual representations of states (e.g., estimated joint positions) of the robot 102 shown in the output video 117, the output image data 129, or both to corresponding tasks described in the prompt 123. Accordingly, the AI policy model 113 may be trained to identify tasks to be performed by the robot 102 to complete operations in accordance with the simulated movement of the robot 102 in the output video 117, the output image data 129, or both. For example, the AI policy model 113 may be trained to identify movements of the robot 102 relative to a simulated object to permit the robot 102 to interface with an actual object in the environment 100.

In an example, the image data 119 may show an object and an effector of the robot 102 and the prompt 123 may state, “generate a video of the effector grabbing the object.” In this example, the computing device 104 may execute the AI model 112 to generate the output video 117 showing the effector moving to interface with the object. In addition, the computing device 104 may train the AI policy model 113 using the output video 117 to identify or otherwise determine movements of the effector of the robot 102 to interface with an actual object in the environment 100.

The computing device 104 may iteratively train the AI policy model 113 in relation to different objects or types of objects to cause the AI model 112 to generate multiple instances of the output video 117 directed to different movements, objects, object types, or any other appropriate factor. The multiple instances of the output video 117 may be used to generalize movements to be made by the robot 102 to interface with a range of objects or object types.

In some embodiments, the AI model 112 may generate multiple videos based on the input data 110. Each of the videos may include a different simulated movement of the robot 102. For example, each of the videos may include a different simulated movement of the robot 102 relative to a simulated object. In these and other embodiments, the computing device 104 may select one or more of the videos to be the output video 117. The computing device 104 may select the one or more videos to be the output video 117 based on operator input (e.g., input received via the user device 120) or based on the scores of the different videos.

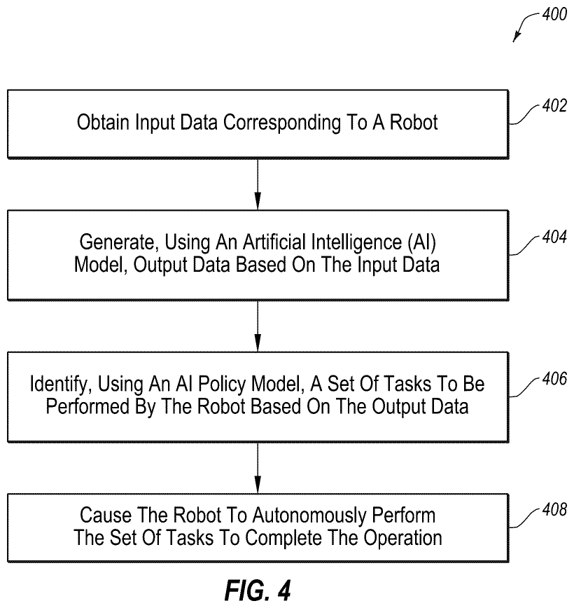

FIG. 4 illustrates a flowchart of an example method 400 to identify a set of tasks to be performed by a robot to complete an operation, in accordance with at least one embodiment described in the present disclosure. The method 400 may be performed by any suitable system, apparatus, or device with respect to identifying the set of tasks to be performed by the robot. For example, the computing device 104 of FIG. 1 may perform or direct performance of one or more of the operations associated with the method 400. The method 400 may include one or more blocks 402, 404, 406, or 408. Although illustrated with discrete blocks, the steps and operations associated with one or more of the blocks of the method 400 may be divided into additional blocks, combined into fewer blocks, or eliminated, depending on the particular implementation.

At block 402, input data corresponding to a robot may be obtained. For example, the computing device 104 of FIG. 1 may obtain the input data 110 from the sensor 114, the user device 120, or audibly from an operator. At block 404, output data may be generated based on the input data using an AI model. The output data may be representative of a state of the robot. For example, the computing device 104 may execute the AI model 112 to generate the output data 127 based on the input data 110. The output data 127 may represent or show one or more states (e.g., positions) of the robot 102.

At block 406, a set of tasks to be performed by the robot may be identified based on the output data using an AI policy model. The set of tasks may involve movement of the robot associated with the state of the robot to perform an operation. For example, the computing device 104 of FIG. 1 may execute the AI policy model 113 to identify the set of tasks based on the output data 127 and the set of tasks may involve movements of the robot 102 to perform the tasks and complete the operation. At block 408, the robot may be caused to autonomously perform the set of tasks to complete the operation. For example, the computing device 104 of FIG. 1 may control actuators or other components of the robot 102 to cause the robot 102 to perform the set of tasks and complete the operation.

Modifications, additions, or omissions may be made to the method 400 without departing from the scope of the present disclosure. For example, the operations of method 400 may be implemented in differing order. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the described embodiments.

FIG. 5 illustrates an example computing system 500 that may be used for an autonomous robot or user device, in accordance with at least one embodiment of the present disclosure. The computing system 500 may be configured to implement or direct one or more operations associated with autonomous operations of the robot 102, which may include operation of the computing device 104, the user device 120, the robot 102, or some combination thereof. The computing system 500 may include a processor 502, a memory 504, a data storage 506, and a communication unit 508, which all may be communicatively coupled. In some embodiments, the computing system 500 may be part of any of the systems or devices described in this disclosure. For example, the computing system 500 may be configured to perform one or more of the tasks described above with respect to the computing device 104, the user device 120, and/or the robot 102.

The processor 502 may include any computing entity, or processing device including various computer hardware or software modules and may be configured to execute instructions stored on any applicable computer-readable storage media. For example, the processor 502 may include a microprocessor, a microcontroller, a parallel processor such as a graphics processing unit (GPU) or tensor processing unit (TPU), a digital signal processor (DSP), an application-specific integrated circuit (ASIC), a Field-Programmable Gate Array (FPGA), or any other digital or analog circuitry configured to interpret and/or to execute program instructions and/or to process data.

Although illustrated as a single processor in FIG. 5, it is understood that the processor 502 may include any number of processors distributed across any number of networks or physical locations that are configured to perform individually or collectively any number of operations described herein.

In some embodiments, the processor 502 may be configured to interpret and/or execute program instructions and/or process data stored in the memory 504, the data storage 506, or the memory 504 and the data storage 506. In some embodiments, the processor 502 may fetch program instructions from the data storage 506 and load the program instructions in the memory 504. After the program instructions are loaded into memory 504, the processor 502 may execute the program instructions.

For example, in some embodiments, the processor 502 may be configured to interpret and/or execute program instructions and/or process data stored in the memory 504, the data storage 506, or the memory 504 and the data storage 506. The program instruction and/or data may be related to an operator directed autonomous system such that the computing system 500 may perform or direct the performance of the operations associated therewith as directed by the instructions.

The memory 504 and the data storage 506 may include computer-readable storage media or one or more computer-readable storage mediums for carrying or having computer-executable instructions or data structures stored thereon. Such computer-readable storage media may be any available media that may be accessed by a computer, such as the processor 502.

By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store particular program code in the form of computer-executable instructions or data structures and which may be accessed by a computer. Combinations of the above may also be included within the scope of computer-readable storage media.

Computer-executable instructions may include, for example, instructions and data configured to cause the processor 502 to perform a certain operation or group of operations as described in this disclosure. In these and other embodiments, the term “non-transitory” as explained in the present disclosure should be construed to exclude only those types of transitory media that were found to fall outside the scope of patentable subject matter in the Federal Circuit decision of In re Nuijten, 500 F.3d 1346 (Fed. Cir. 2007). Combinations of the above may also be included within the scope of computer-readable media.

The communication unit 508 may include any component, device, system, or combination thereof that is configured to transmit or receive information over a network. In some embodiments, the communication unit 508 may communicate with other devices at other locations, the same location, or even other components within the same system. For example, the communication unit 508 may include a modem, a network card (wireless or wired), an infrared communication device, a wireless communication device (such as an antenna implementing 4G (LTE), 4.5G (LTE-A), and/or 5G (mmWave) telecommunications), and/or chipset (such as a Bluetooth® device (e.g., Bluetooth 5 (Bluetooth Low Energy)), an 802.6 device (e.g., Metropolitan Area Network (MAN)), a Wi-Fi device (e.g., IEEE 802.11ax, a WiMAX device, cellular communication facilities, etc.), and/or the like. The communication unit 508 may permit data to be exchanged with a network and/or any other devices or systems described in the present disclosure.

Modifications, additions, or omissions may be made to the computing system 500 without departing from the scope of the present disclosure. For example, in some embodiments, the computing system 500 may include any number of other components that may not be explicitly illustrated or described. Further, depending on certain implementations, the computing system 500 may not include one or more of the components illustrated and described.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A method comprising:
obtaining input data corresponding to a robot;
generating, using an artificial intelligence (AI) model, output data based on the input data, the output data being representative of a state of the robot;
identifying, using an AI policy model, a set of tasks to be performed by the robot based on the output data, the set of tasks involving movement of the robot associated with the state of the robot to perform an operation; and
causing the robot to autonomously perform the set of tasks to complete the operation.

2. The method of claim 1, wherein the input data comprises at least one of:
an instruction provided by an operator, the instruction identifying a detail related to the set of tasks;
an instruction provided by the operator, the instruction identifying a detail related to a corresponding task;
a plurality of images of the robot associated with the corresponding task;
a video of a related device performing a related task;
a video of the robot performing the corresponding task; or
a start image of the robot associated with the corresponding task.

3. The method of claim 1, wherein:
the input data comprises a start image representative of a starting state of the robot;
the output data comprises a final image of the robot based on the start image; and
the state comprises a final state of the robot shown in the final image.

4. The method of claim 3, wherein:
the output data comprises a video of the robot based on the start image, the video representative of a plurality of intermediate states of the robot; and
the plurality of intermediate states comprises states between the starting state and the final state.

5. The method of claim 1, wherein the generating, using the AI model, the output data based on the input data comprises estimating a plurality of positions of a joint of the robot based on the input data, wherein the state comprises the plurality of positions of the joint.

6. The method of claim 1, wherein the causing the robot to autonomously perform the set of tasks to complete the operation comprises at least one of:
causing a current operation being performed by the robot to be updated in accordance with the set of tasks;
creating an updated parameter of the current operation in accordance with the set of tasks; or
updating a parameter of the current operation in accordance with the set of tasks.

7. The method of claim 1, wherein:
the input data comprises:
an instruction provided by an operator, the instruction identifying a detail related to the set of tasks; and
a start image representative of a starting state of the robot; and
the output data comprises a video of the robot based on the start image and the detail identified in the instruction.

8. The method of claim 1, wherein:
the AI policy model is initially configured to identify tasks to be performed by the robot in accordance with initial parameters related to the tasks; and
the method comprises training the AI policy model using training output data to identify tasks to be performed by the robot in accordance with states of the robot and the initial parameters of the AI policy model.

9. A system comprising:
one or more computer readable media configured to store instructions; and
a processor coupled to the computer readable media, the processor configured to execute the instructions to cause or direct the system to perform operations, the operations comprising:
obtaining input data corresponding to a robot;
generating, using an artificial intelligence (AI) model, output data based on the input data, the output data being representative of a state of the robot;
identifying, using an AI policy model, a set of tasks to be performed by the robot based on the output data, the set of tasks involving movement of the robot associated with the state of the robot to perform an operation; and
causing the robot to autonomously perform the set of tasks to complete the operation.

10. The system of claim 9, wherein the input data comprises at least one of:
an instruction provided by an operator, the instruction identifying a detail related to the set of tasks;
an instruction provided by the operator, the instruction identifying a detail related to a corresponding task;
a plurality of images of the robot associated with the corresponding task;
a video of a related device performing a related task;
a video of the robot performing the corresponding task; or
a start image of the robot associated with the corresponding task.

11. The system of claim 9, wherein:
the input data comprises a start image representative of a starting state of the robot;
the output data comprises a final image of the robot based on the start image; and
the state comprises a final state of the robot shown in the final image.

12. The system of claim 11, wherein:
the output data comprises a video of the robot based on the start image, the video representative of a plurality of intermediate states of the robot; and
the plurality of intermediate states comprises states between the starting state and the final state.

13. The system of claim 9, wherein the operation generating, using the AI model, the output data based on the input data comprises estimating a plurality of positions of a joint of the robot based on the input data, wherein the state comprises the plurality of positions of the joint.

14. The system of claim 9, wherein the operation causing the robot to autonomously perform the set of tasks to complete the operation comprises at least one of:
causing a current operation being performed by the robot to be updated in accordance with the set of tasks;
creating an updated parameter of the current operation in accordance with the set of tasks; or
updating a parameter of the current operation in accordance with the set of tasks.

15. The system of claim 9, wherein:
the input data comprises:
an instruction provided by an operator, the instruction identifying a detail related to the set of tasks; and
a start image representative of a starting state of the robot; and
the output data comprises a video of the robot based on the start image and the detail identified in the instruction.

16. The system of claim 9, wherein:
the AI policy model is initially configured to identify tasks to be performed by the robot in accordance with initial parameters related to the tasks; and
the operations comprise training the AI policy model using training output data to identify tasks to be performed by the robot in accordance with states of the robot and the initial parameters of the AI policy model.

17. A non-transitory computer-readable medium having computer-readable instructions stored thereon that are executable by a processor to perform or control performance of operations comprising:
obtaining input data corresponding to a robot;
generating, using an artificial intelligence (AI) model, output data based on the input data, the output data being representative of a state of the robot;
identifying, using an AI policy model, a set of tasks to be performed by the robot based on the output data, the set of tasks involving movement of the robot associated with the state of the robot to perform an operation; and
causing the robot to autonomously perform the set of tasks to complete the operation.

18. The non-transitory computer-readable medium of claim 17, wherein:
the input data comprises a start image representative of a starting state of the robot;
the output data comprises a final image of the robot based on the start image; and
the state comprises a final state of the robot shown in the final image.

19. The non-transitory computer-readable medium of claim 17, wherein the operation generating, using the AI model, the output data based on the input data comprises estimating a plurality of positions of a joint of the robot based on the input data, wherein the state comprises the plurality of positions of the joint.

20. The non-transitory computer-readable medium of claim 17, wherein the operation causing the robot to autonomously perform the set of tasks to complete the operation comprises at least one of:
causing a current operation being performed by the robot to be updated in accordance with the set of tasks;
creating an updated parameter of the current operation in accordance with the set of tasks; or
updating a parameter of the current operation in accordance with the set of tasks.
